(19) United States
(12) Patent Application Publication
(10) Pub. No.: US 2008/0276763 A1
(43) Pub. Date: Nov. 13, 2008

(54) NO MESS OIL FILTER REMOVAL TOOL

(76) Inventor: Michael D. Greenberg, Bloomfield, CT (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/746,763

(22) Filed: May 10, 2007

(51) Int. Cl. B25B 27/00

(52) U.S. Cl. 81/121.1

(57) ABSTRACT

An oil filter removal tool includes a member for providing a reservoir to capture leakage oil as the oil filter is removed from a vehicle.

### BACKGROUND OF THE INVENTION

This application relates to an oil filter removal tool wherein a chamber is provided to catch leakage oil as the filter is being removed.

Oil filters are utilized in many vehicle applications. Typically, an oil filter is placed in the path of an oil circuit, and acts to filter impurities from the oil. Periodically, the oil filter must be changed.

Traditionally, a tool such as a band-type removal wrench is placed around the outer circumference of a filter, and the filter is turned. As the filter is turned, it becomes unsecured to the vehicle structure, and can be removed for replacement. Other methods include a socket type device driven by a ratchet.

However, with these prior art tools, some oil tends to leak along the outer periphery of the filter as it is removed. Thus, a user's hands often become soiled when removing the oil filter and any oil spillage must be cleaned up and disposed of in an environmentally conscious manner. This oil may also include impurities such as lead from main engine bearings.

### SUMMARY OF THE INVENTION

In a disclosed embodiment of this invention, an oil filter removal tool includes a member to surround the outer periphery of the oil filter and capture and collect any leakage oil. In one embodiment, a bellows extends around the filter, with a drive structure adjacent the bottom of the bellows. In another embodiment, a slip-on cup surrounds the filter, and a separate tool is then used to removed the filter. Either embodiment serves to provide a reservoir to capture leakage oil.

These and other features of the present invention can be best understood from the following specification and drawings, the following of which is a brief description.

### BRIEF DESCRIPTION OF THE DRAWINGS

FIG. 1A is a cross-sectional view through a first tool embodiment.

FIG. 1B is an exploded view showing a portion of the first tool embodiment.

FIG. 1C shows another optional embodiment.

FIG. 1D shows yet another embodiment.

FIG. 2 shows the relationship between a filter and the tool. (Not sure FIG. 2 is required.)

FIG. 3 is a cross-sectional view through a second tool embodiment.

FIG. 4 is a cross-sectional view through another tool embodiment.

### DETAILED DESCRIPTION OF THE PREFERRED EMBODIMENT

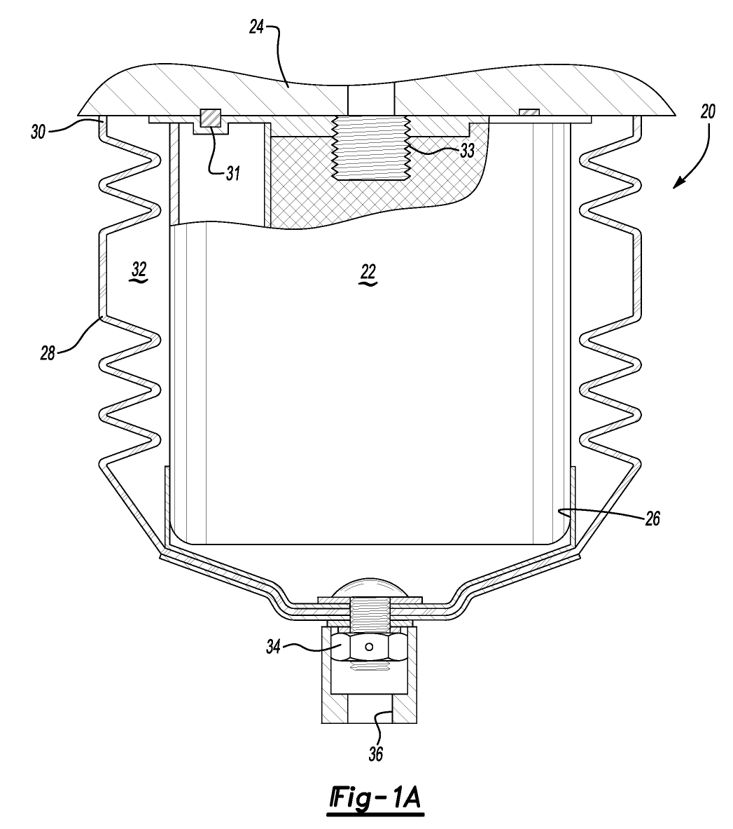

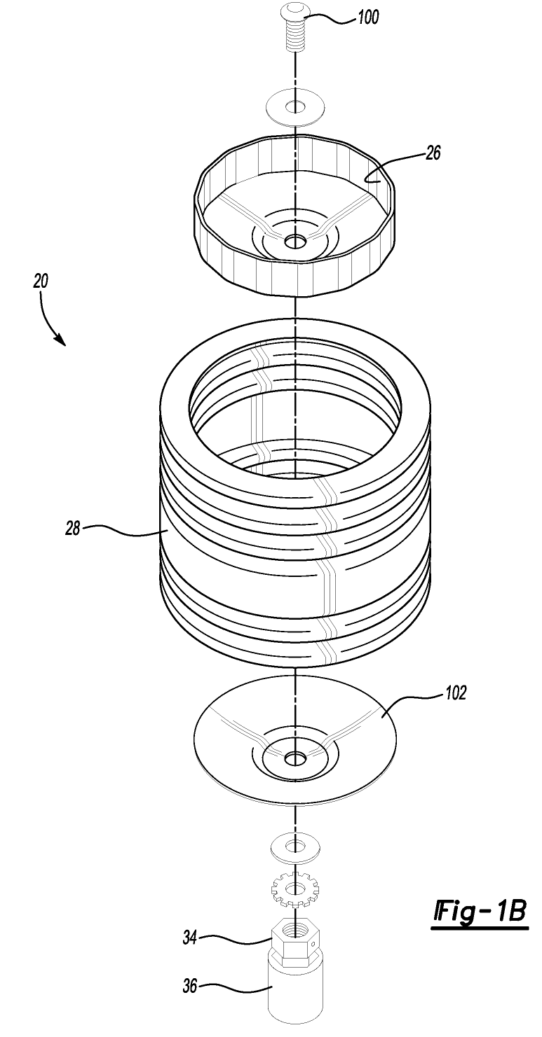

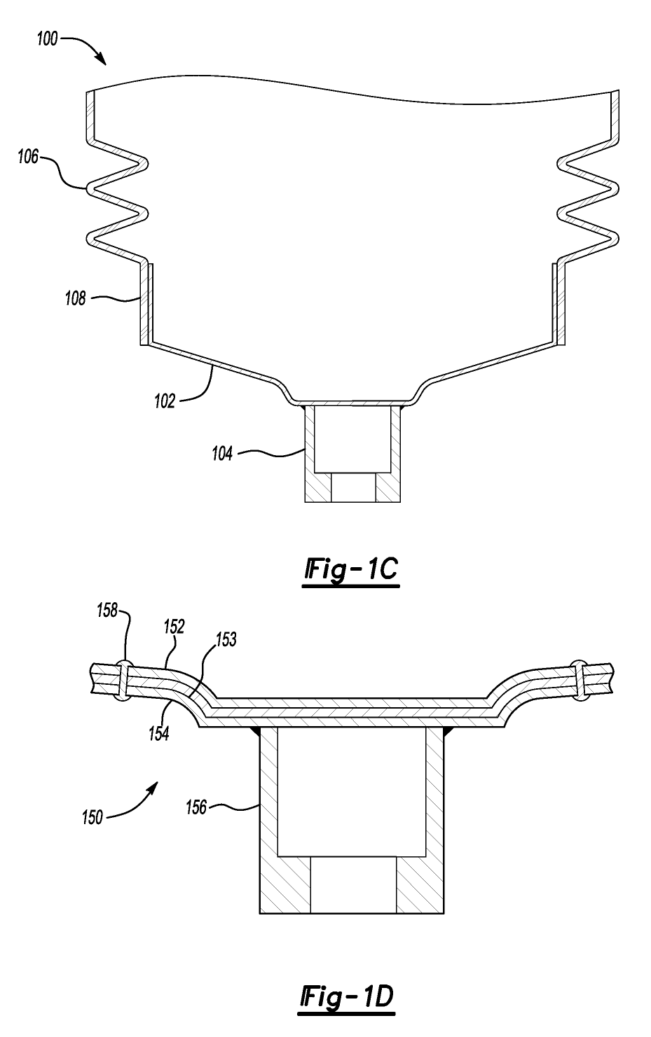

An oil removal tool 20 is illustrated in FIG. 1A. As shown, an oil filter 22 is typically secured to a vehicle engine. A holding and drive structure 26 within a bellows 28 is relatively rigid, and is sized to receive a bottom peripheral surface of the oil filter 22. An upper end 30 of the bellows surrounds an upper end of the oil filter 22 adjacent to the oil seal surface, and provides a reservoir 32 to capture leakage oil as oil filter 22 is removed. A drive is provided, such as a standard square drive 36, and allows the socket 26 and bellows 28 to be turned. The standard square drive may be formed integrally with a portion of the tool, or may be welded, or otherwise attached to the tool. The standard square drive receives the tool internally to turn the tool and the filter, or may include an external hex to allow a wrench to drive the tool. As the bellows 28 turns, the structure 26 simultaneously turns the filter 22, and the filter is removed from the vehicle frame 24. The bellows is spring loaded against the mating seal surface through its own natural spring rate. As the filter 22 comes away from the vehicle frame 24, the upper surface of the bellows remains in contact with the vehicle frame, thus, leakage oil will be captured within the reservoir 32. As can be appreciated, the bellows is resilient and allows the tool to conform to frame 24 to reliably capture the oil and to accommodate filters 22 of various lengths.

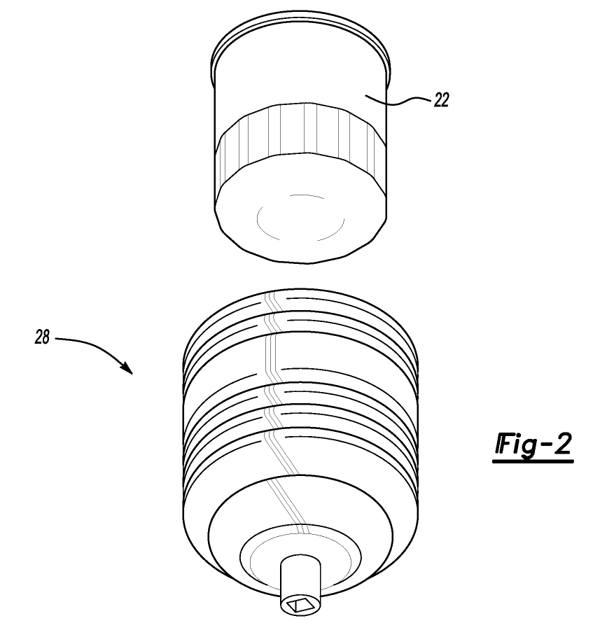

As shown, a filter port 33 may be positioned on the vehicle frame 24 to receive a filter and gasket 31. As can be appreciated from FIG. 2, the structure 26 will capture and tightly hold the filter 22.

FIG. 1B is an exploded view showing the filter 22 removed from the bellows 28. A bolt 100 captures a plate 102 with the nut 34, and assorted sealing washers, etc. The socket is permanently attached to provide a sealed square drive.

FIG. 1C shows an embodiment 100 wherein a base 102 is welded to a drive 104, or may be formed as a one-piece glass reinforced injection molded part with or without insert structure as deemed appropriate. The bellows 106 may be bonded or integrally molded to the base 102. A bond 108 is utilized at the intersection of 102 and 106, providing a seal and mechanical retention. This may also be a tight snap fit.

FIG. 1D shows an embodiment 150, wherein rivets 158 secure the several layers 152, 153, and 154. The drive 156 is secured to the layer 154 in some manner.

In sum, any method of attaching a leak free drive to the member may be utilized, and various types of drives may be utilized.

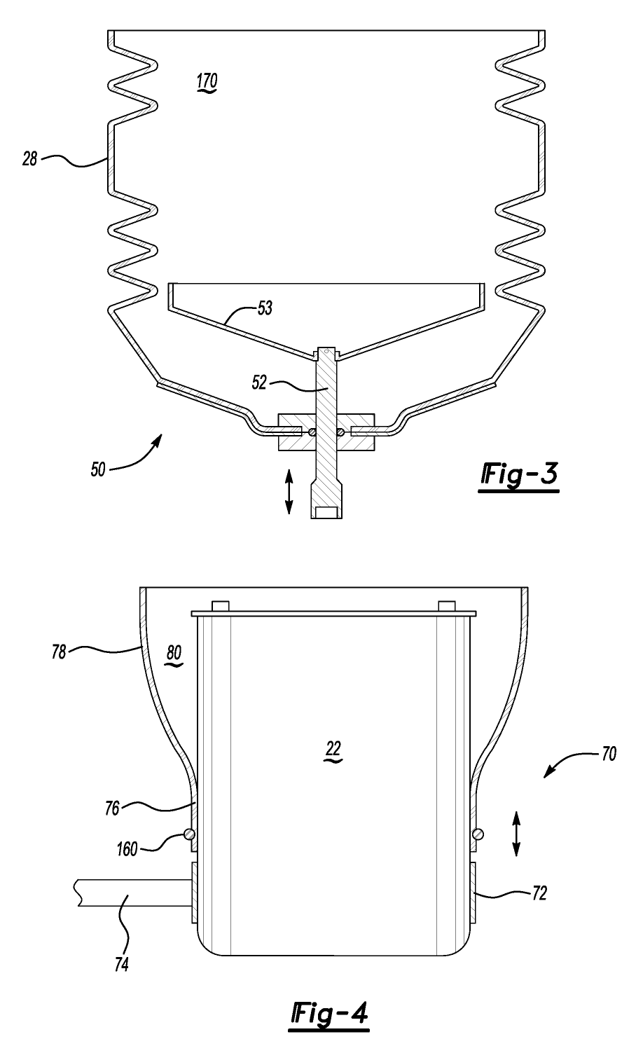

FIG. 3 shows another embodiment 50, wherein a drive tool 52 at the bottom of the bellows 28 has a standard drive structure 53 that serves to move onto mating structure on the oil filter (removed for clarity), and drive the oil filter for removal. Again, a leak free reservoir 170 is provided by the bellows 28. The choice of the drive surface 26 or the drive tool 52 for driving the filter will be dependent upon the type of filter, thus providing more options. Seals such as o rings at the base of this assembly allow drive tool 52 to be axially positioned as required for filter height differences while providing a leak free seal at the base of this assembly.

FIG. 4 shows another embodiment 70. In embodiment 70, a strap wrench 72 and 74, as are traditionally utilized, can be used to remove the filter 22. A snug fit, slip-on cup 76 has a radially outwardly extending lip 78 providing the reservoir 80. Again, as the filter 22 is removed, leakage oil will be captured in the reservoir 80. A reinforcement such as a spring or resilient strap 160 may serve to hold the cup 76 on the filter 22. The cup 76 may be a snug fit, but still able to slide and flex along the filter. While a strap wrench 74 is shown in FIG. 4, a socket drive, or other type of drive may be utilized.

In the embodiments utilizing bellows, of course the number and shape of the bellows may vary.

Although embodiments of this invention have been disclosed, a worker of ordinary skill in this art would recognize that certain modifications would come within the scope of this invention. For that reason, the following claims should be studied to determine the true scope and content of this invention.

What is claimed is:

1. An oil filter removal tool comprising;
a member having an upper surface to be spaced slightly away from a radially outer surface of an oil filter, said member defining a reservoir for capturing leakage oil as the oil filter is removed.

2. The oil filter removal tool as set forth in claim 1, wherein the member is utilized in combination with a tool for turning the oil filter for removal.

3. The oil filter removal tool as set forth in claim 2, wherein the tool is attached to the member.

4. The oil filter removal tool as set forth in claim 3, wherein the member is bellows shaped.

5. The oil filter removal tool as set forth in claim 1, wherein the tool that is used is a tool separate from the member.

6. The oil filter removal tool as set forth in claim 5, wherein the tool is a drive strap.

7. The oil filter removal tool as set forth in claim 1, wherein the tool for turning the filter includes an inner surface in a holding structure, which closely surrounds a peripheral surface of the filter to provide friction to the filter as the member is turned.

8. The oil filter removal tool as set forth in claim 1, wherein the member is bellows shaped.

9. The oil filter removal tool as set forth in claim 1, wherein the tool for turning the filter includes a nut at a bottom of the member.

10. A method of oil filter removal comprising;
providing a member having an upper surface to be spaced slightly away from a radially outer surface of an oil filter, and said member defining a reservoir for capturing leakage oil as the oil filter is removed, and removing the oil filter and capturing leaking oil in the reservoir.

11. The method as set forth in claim 10, wherein the member is utilized in combination with a tool for turning the oil filter for removal.

12. The method as set forth in claim 11, wherein the tool is attached to the member.

13. The method as set forth in claim 12, wherein the member is bellows shaped.

14. The method as set forth in claim 10, wherein the tool that is used is a tool separate from the member.

15. The oil filter removal tool as set forth in claim 10, wherein the tool is a drive strap.

16. The method as set forth in claim 10, wherein the tool for turning the filter includes an inner surface in the member, which closely surrounds a surface of the filter to provide friction to the filter as the member is turned.

17. The method as set forth in claim 9, wherein the member is bellows shaped.

18. The method as set forth in claim 10, wherein the tool for turning the filter includes a nut at a bottom of the member.
